(19) United States
(12) Patent Application Publication
(10) Pub. No.: US 2007/0089969 A1
(43) Pub. Date: Apr. 26, 2007

(54) Wood conveying apparatus and system

(76) Inventors: Lonnie Sifers, Covington, VA (US); Calvin W. Caldwell, Covington, VA (US)

Correspondence Address: THOMPSON HINE L.L.P., P.O. BOX 8801, DAYTON, OH, 45401-8801, US

(21) Appl. No.: 11/254,372

(22) Filed: Oct. 20, 2005

(51) Int. Cl. B65G 13/06

(52) U.S. Cl. 198/784

(57) ABSTRACT

A conveying roll including a generally cylindrical drum portion and at least one separating bar connected to and extending generally axially across the drum portion, wherein at least a first portion of the bar has a first radial length and at least a second portion of the bar has a second radial length, wherein the first radial length is generally larger than the second radial length.

### BACKGROUND

The present application relates to conveying rolls for wood conveyors and the like and, more particularly, separating bars for conveying rolls.

Wood or log conveying systems typically include a series of conveyor belts positioned and aligned to transport logs from a starting point (e.g., a log pile) to an end point (e.g., a wood chipper). The conveyor belt sections often are separated by one or more feeding rolls or speed-up rolls.

Speed-up rolls typically are ribbed with axial separating bars spaced about the circumference of the rolls. The speed-up rolls rotate at variable speeds significantly faster than the speed of the conveyor belts such that the ribbed axial bars engage and pull the logs along the conveyor while separating the logs across the conveyor belts.

Prior art wood conveying systems and speed-up rolls are described in greater detail in U.S. Pat. No. 6,253,813 to Kube et al., U.S. Pat. No. 4,901,778 to Fenton and U.S. Pat. No. 1,241,925 to Coleman, the entire contents of which are incorporated herein by reference.

Prior art conveyor systems have presented several disadvantages. For example, prior art speed-up rolls have a uniform or constant axial profile. Therefore, such rolls treat all logs moving along the conveyor system in a similar manner, thereby reducing the likelihood that adjacent logs having a similar size and shape will be separated, resulting in a choking or backup of the conveying process. Furthermore, prior art speed-up rolls often include separating bars welded directly onto the roll, thereby making it difficult to repair or replace the bars.

Accordingly, there is a need for a log conveying apparatus, method and system having improved log separating capabilities. Furthermore, there is a need for an apparatus, method and system for quickly and easily repairing or replacing the separating bars of a log conveying system.

### SUMMARY

In one aspect, the wood conveying apparatus and system is directed to a conveying roll including a generally cylindrical drum portion and at least one separating bar connected to and extending generally axially across the drum portion, wherein at least a first portion of the bar has a first radial length and at least a second portion of the bar has a second radial length, wherein the first radial length is generally larger than the second radial length.

In another aspect, the wood conveying apparatus and system is directed to a conveying roll including a generally cylindrical drum portion and about 2 to about 50 separating bars generally equidistantly spaced and removeably connected to the drum portion, wherein the separating bars extend generally radially from and generally axially across the drum portion and include a plurality of teeth, and wherein at least a first portion of the bar has a first radial length and at least a second portion of the bar has a second radial length, wherein the first radial length is larger than the second radial length.

In another aspect, the wood conveying apparatus and system is directed to a system for transporting a substrate from a first location to a second location including at least one conveying roll, the conveying roll including a generally cylindrical drum portion and at least one separating bar connected to and extending axially across the drum portion, wherein at least a first portion of the bar has a first radial length and at least a second portion of the bar has a second radial length, wherein the first portion has a first outer rotational speed and the second portion has a second, generally slower, outer rotational speed, and at least one conveyor belt positioned generally adjacent to the conveying roll, the conveyor belt having a belt speed that is less than the first and second outer rotational speeds.

Other aspects of the wood conveying apparatus and system will become apparent from the following description, the accompanying drawings and the appended claims.

### BRIEF DESCRIPTION OF THE DRAWINGS

FIG. 1 is a schematic illustration of one aspect of the wood conveying apparatus and system;

FIG. 2A is an end elevational view of one aspect of a speed-up roll according to the wood conveying apparatus and system;

FIG. 2B is a front elevational view of the speed-up roll of FIG. 2A; and

FIG. 3 is a front elevational view of a separating bar of the speed-up roll of FIG. 2A.

### DETAILED DESCRIPTION

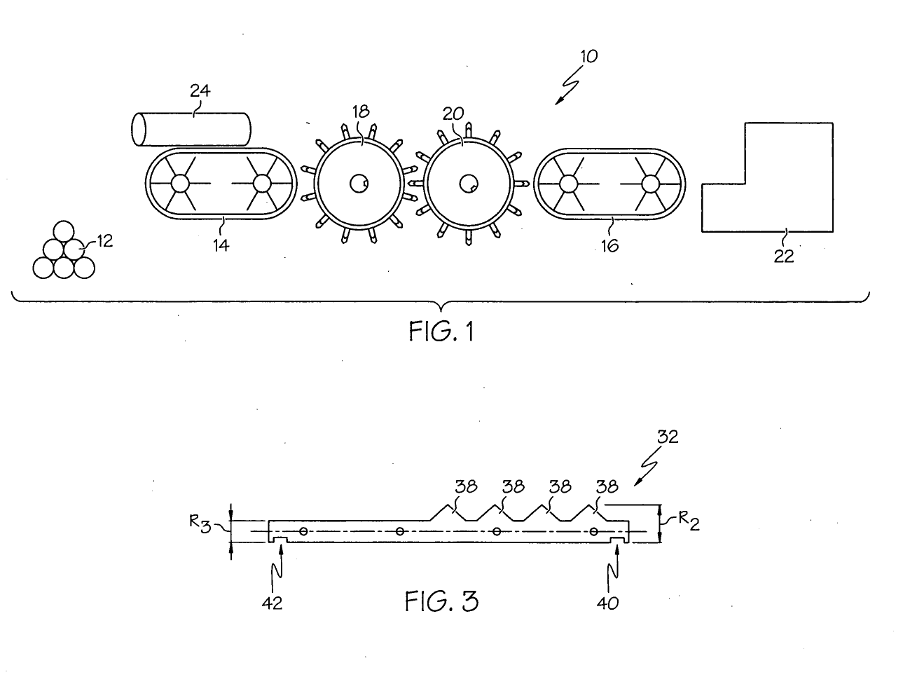

As shown in FIG. 1, a wood conveying system, generally designated 10, may include a wood supply 12, a number of conveyor belts 14, 16, a number of conveying rolls (e.g., speed-up rolls) 18, 20 and a processing unit 22 such as a wood chipper. The first conveyor belt 14 may receive a log (or multiple logs) 24 from the wood supply 12 and pass the log 24 to the speed-up rolls 18, 20, which in turn pass the log 24 to the second conveyor belt 16, which passes the log 24 to the wood chipper 22. Those skilled in the art will appreciate that various quantities, combinations, orientations and configurations of conveyor belts and speed-up roll are possible and within the scope of the present application.

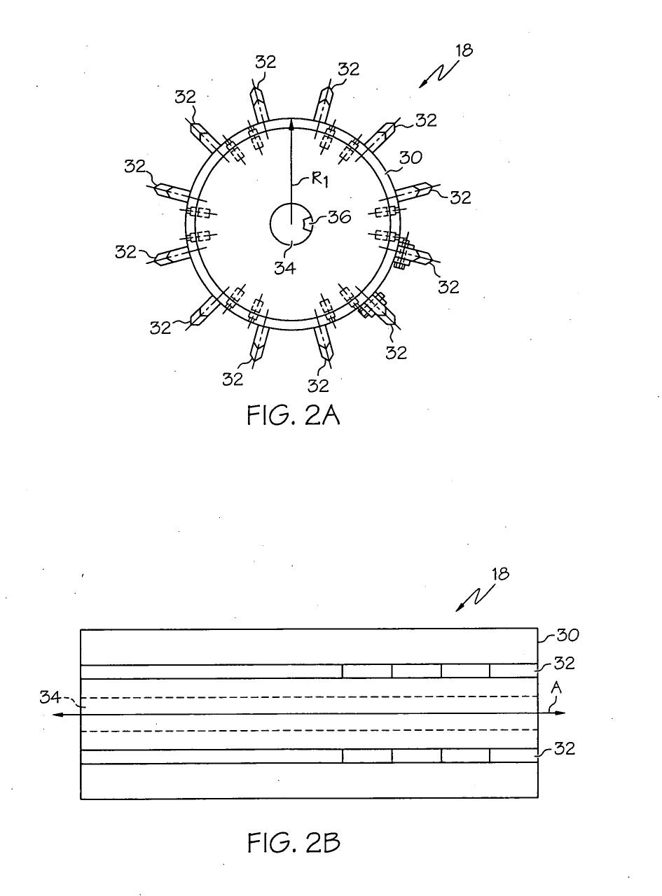

As shown in FIGS. 2A and 2B, speed-up roll 18 (and/or roll 20) may include a drum portion 30, a plurality of separating bars 32 and a central drive channel 34. The drum portion 30 may be generally cylindrical and may have a radius R₁. The radius R₁ may be selected based on process conditions, conveyor belt width, log diameter and the like. For example, the radius R₁ of the drum portion 30 may be about 6 inches to about 8 inches.

The central drive channel 34 may include a notch 36 and may be sized to receive a drive shaft (not shown) therein such that rotation of the drive shaft may be translated into corresponding rotation of the roll 18 about an axis of rotation A. However, those skilled in the art will appreciate that the central drive channel 34 may be replaced or combined with any available technique or mechanism for rotating the roll 18 about the axis A.

The separating bars 32 may extend axially along the length of the drum 30 and may be spaced generally equidistantly about the periphery of the drum 30. Furthermore, the bars 32 may be connected to the drum 30 such that the bars 32 extend generally radially from the drum 30, as shown in FIG. 2A. In another aspect, the bars 32 may be randomly or non-equidistantly spaced about the drum 30 and/or may extend from the drum 30 at various angles.

The bars 32 may be connected to the drum 30 in any known way, such as welds, screws, rivets, bolts, clamps or the like. In one aspect, the bars 32 may be removeably connected to the drum 30.

As shown in FIG. 3, the separating bars 32 may include a plurality of teeth 38 extending generally radially from the bars 32. The teeth 38 may have any size and/or shape. For example, as shown in FIG. 3, the teeth 38 may be generally triangular. Alternatively, the teeth 38 may be rectangular, polygonal, round, obround or the like in front view or may have various irregular shapes. In one aspect, the shape and/or size of the teeth 38 may be selected based on the size of the logs or the type of wood being processed by the system 10. In another aspect, the shape and/or size of the teeth 38 may be selected such that the separating bars 32 are capable of gripping or “biting” wooden logs.

As shown in FIG. 3, the teeth 38 may extend over only a portion of the axial length of the bar 32, thereby providing the bar 32 with a first radial length R₂ near the first end 40 of the bar 32 and a second, shorter, radial length R₃ near the second end 42 of the bar (i.e., the bar 32 may have an asymmetric profile in front view). The radial length R₂ may be, for example, about 2.5 inches to about 3.5 inches and the radial length R₃ may be, for example, about 1.5 inches to about 2.5 inches. Alternatively, the teeth 38 may extend across the entire axial length of the separating bar 32, wherein the teeth 38 positioned near the first end 40 of the bar 32 are radially longer than the teeth 38 positioned near the second end 42 of the bar 32, thereby providing the bar 32 with an asymmetric profile in front view.

Accordingly, those skilled in the art will appreciate that the outer or surface rotational speed V₁ of the separating bars 32 near the first end 40 of the bars 32 may be calculated as follows:
V₁=2π(R₁+R₂)ω
and the outer or surface rotational speed V₂ of the separating bars 32 near the second end 42 of the bars 32 may be calculated as follows:
V₂=2π(R₁+R₃)ω
wherein ω is the angular velocity of the drum 30.

Thus, when R₂ is greater than R₃, the rotational speed V₁ near the first end 40 of the bars 32 will be greater than the rotational speed V₂ near the second end 42 of the bars 32. Therefore, a single roll 18 may have two or more different surface speeds (e.g., V₁ and V₂) by providing the separating bars 32 with an asymmetric profile, thereby improving the ability of the roll 18 to separate and convey adjacent logs 24.

At this point, those skilled in the art will appreciate that various shapes and configurations of the separating bars 32 will achieve the asymmetric profile according to the wood conveying apparatus and system.

Although the wood conveying apparatus and system is shown and described with respect to certain aspects, modifications may occur to those skilled in the art upon reading the specification. The wood conveying apparatus and system includes all such modifications and is limited only by the scope of the claims.

What is claimed is:

1. A conveying roll comprising:
a generally cylindrical drum portion; and
at least one separating bar connected to and extending generally axially across said drum portion, wherein at least a first portion of said bar has a first radial length and at least a second portion of said bar has a second radial length, wherein said first radial length is generally larger than said second radial length.

2. The conveying roll of claim 1 wherein said separating bar extends generally radially from said drum portion.

3. The conveying roll of claim 1 wherein said drum portion includes about 2 to about 50 of said separating bars connected to and extending axially across said drum portion.

4. The conveying roll of claim 3 wherein said separating bars are equidistantly spaced about said drum portion.

5. The conveying roll of claim 1 wherein said separating bar is removeably connected to said drum portion.

6. The conveying roll of claim 1 wherein said separating bar includes at least two teeth extending generally radially therefrom.

7. The conveying roll of claim 6 wherein said teeth are generally triangular in front view.

8. The conveying roll of claim 6 wherein said teeth extend generally across said separating bar.

9. The conveying roll of claim 6 wherein said teeth extend generally partially across said separating bar.

10. The conveying roll of claim 1 wherein said first radial length is about 2.5 inches to about 3.5 inches and said second radial length is about 1.5 inches to about 2.5 inches.

11. A conveying roll comprising:
a generally cylindrical drum portion; and
about 2 to about 50 separating bars generally equidistantly spaced and removeably connected to said drum portion, wherein said separating bars extend generally radially from and generally axially across said drum portion and include a plurality of teeth, and wherein at least a first portion of said bar has a first radial length and at least a second portion of said bar has a second radial length, wherein said first radial length is larger than said second radial length.

12. A conveying system for transporting a substrate from a first location to a second location comprising:
at least one conveying roll, said conveying roll including a generally cylindrical drum portion and at least one separating bar connected to and extending axially across said drum portion, wherein at least a first portion of said bar has a first radial length and at least a second portion of said bar has a second radial length, wherein said first portion has a first outer rotational speed and said second portion has a second, generally larger, outer rotational speed; and
at least one conveyor belt positioned generally adjacent to said conveying roll, said conveyor belt having a belt speed, wherein said belt speed is less than said first and second outer rotational speeds.

13. The system of claim 12 further comprising a processing unit, wherein said conveying roll and said conveyor belt move said substrate to said processing unit.

14. The system of claim 13 wherein said substrate is a log.

15. The system of claim 12 wherein said separating bar extends generally radially from said drum portion.

16. The system of claim 12 wherein said drum portion includes about 2 to about 50 of said separating bars connected to and extending axially across said drum portion.

17. The system of claim 16 wherein said separating bars are equidistantly spaced about said drum portion.

18. The system of claim 12 wherein said separating bar is removeably connected to said drum portion.

19. The system of claim 12 wherein said separating bar includes at least two teeth extending generally radially therefrom.

20. The system of claim 19 wherein said teeth extend generally partially across said separating bar.
